(19) United States
(12) Patent Application Publication
(10) Pub. No.: US 2006/0188729 A1
(43) Pub. Date: Aug. 24, 2006

(54) Washable leather with repellency

(76) Inventors: Kai-Volker Schubert, Chadds Ford, PA (US); Andrew Hen Liu, Newark, DE (US); Hansjoerg Scheen, Arcadia, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/063,207

(22) Filed: Feb. 22, 2005

(51) Int. Cl. C08G 18/28; B32B 27/40

(52) U.S. Cl. 428/423.1; 528/70

(57) ABSTRACT

A washable leather having durable oil repellency, durable stain release, and durable water repellency is disclosed and a method of its preparation comprising contacting the leather during tanning with a composition which comprises at least one fluorinated urethane; at least one fluorinated ester; a mixture thereof; or a mixture of at least one fluorinated citrate urethane with at least one fluorinated urethane, at least one fluorinated ester, or a mixture of fluorinated urethane and fluorinated ester.

### FIELD OF THE INVENTION

This invention relates to a method for imparting durable oil repellency, durable stain release, and durable water repellency properties to washable leather, and to the resulting treated leather having such properties.

### BACKGROUND OF THE INVENTION

In U.S. Pat. No. 4,999,024, Scheen disclosed a novel tanning process capable of producing leathers which, in contrast to even those made by the specialized treatment of conventionally tanned leathers, could be washed in water without cracking, drying out, or otherwise deteriorating. Instead, the leathers made by the patented process were soft, supple, and compliant and retained these characteristics, even after repeated washing. The process Scheen disclosed employed a preliminary step in which hides were impregnated with a grease/oil lubricating solution. The impregnated skins were then preserved by tanning to produce a soft and supple leather. Residual lubricating solution in the pores of the leather kept the leather supple even after repeated washing in water.

In U.S. Pat. No. 5,972,037, Scheen described new tanning processes that had further advantages. In particular, Scheen's tanning processes were capable of producing leathers that were washable and dryable even in common household appliances and, in addition, were waterproof, nonflammable, and extremely colorfast. Another advantage of his processes was that the volume of toxic discharges generated in tanning hides was significantly reduced.

Those steps that Scheen considered essential were treating the hide with a pH equalizer and a character builder selected to develop characteristics wanted in the leather; treating the hide with a softening agent to soften the hide and thereby improving the feel of the leather into which the hide is converted; treating the hide with an organic hydrophobe to impart water repellency; and treating the hide with a cationic topping oil in an amount effective to impart a pleasant tactile character.

The Scheen patents teach water repellency and washability, but not how to achieve durable oil repellency and durable stain release. In the leather industry, imparting such easy care properties to leather is a major objective. It is desirable to modify this tanning procedure to include the application of fluorochemical dispersions to leather to impart durable repellency to water- and oil-based stains and to promote durable stain release and still retain its washable properties. Furthermore, it is desirable that the treatment agents employed be effective with essentially no changes in the leather processing steps, be compatible with leather treatment bath formulations, and be applied without the need for additional equipment. The present invention provides such a method.

### SUMMARY OF THE INVENTION

The present invention comprises a method of imparting durable oil repellency, durable stain release, and durable water repellency to washable leather comprising contacting said washable leather with a composition which comprises at least one fluorinated urethane; at least one fluorinated ester; a mixture thereof; or a mixture of at least one fluorinated citrate urethane with at least one fluorinated urethane, at least one fluorinated ester, or a mixture of fluorinated urethane and fluorinated ester.

The present invention further comprises a washable leather treated to provide durable oil repellency, durable stain release, and durable water repellency by contacting said leather with a composition which comprises at least one fluorinated urethane; at least one fluorinated ester; a mixture thereof; or a mixture of at least one fluorinated citrate urethane with at least one fluorinated urethane, at least one fluorinated ester, or a mixture of fluorinated urethane and fluorinated ester.

### DETAILED DESCRIPTION

Tradenames are shown herein in upper case.

The term “(meth)acrylate” is used herein to mean methacrylate or acrylate.

The term “washable leather” is used herein to mean leather that is machine washable in an aqueous system and machine dryable and obtained according to the Scheen patents described above.

The present invention comprises washable leather having durable oil repellency, durable and enhanced water repellency, and durable stain release. The present invention-further comprises a method of imparting durable oil repellency, durable stain release, and durable water repellency to washable leather comprising contacting said washable leather with a composition comprising at least one fluorinated urethane, at least one fluorinated ester, or mixtures thereof. The present invention also comprises the above method wherein the above composition further comprises at least one fluorinated citrate urethane. The fluorinated citrate urethane can be combined with the fluorinated urethane, the fluorinated ester, or mixtures of the fluorinated urethane and fluorinated ester.

The present invention provides fully washable leather that is both washable and dryable in household appliances and has durable water repellency, durable stain protection as well as durable stain release. The leather of the present invention still maintains the softness, suppleness, dimensional stability, and color fastness as taught in U.S. Pat. No. 5,972,037.

Fluorinated additives useful in the practice of the present invention are

fluorinated urethanes, fluorinated esters, and fluorinated citrate urethanes.

Examples of fluorinated urethanes suitable for use in the present invention are polymers described by Del Pesco et al., in U.S. Pat. No. 6,479,612. These polymers have at least one urea linkage derived by contacting (1) at least one polyisocyanate, or mixture of polyisocyanates, (2) at least one fluorocarbon alcohol, fluorocarbon thiol or fluorocarbon amine, (3) at least one straight or branched chain alcohol, amine or thiol, and (4) at least one alcohol containing a sulfonic acid group or its salt, and then (5) optionally at least one linking agent. The fluorinated urethanes are used in the present invention in the form of an aqueous dispersion, typically containing from about 10% to about 35% of fluorinated urethane solids based on the weight of the dispersion.

The polyisocyanate reactant (Reactant 1) provides the backbone of the polymer. Any polyisocyanate having predominately three or more isocyanate groups, or any isocyanate precursor of a polyisocyanate having predominately three or more isocyanate groups, is suitable for use in this invention. It is recognized that minor amounts of diisocyanates may remain in such products. An example of this is a biuret containing residual small amounts of hexamethylene diisocyanate. Particularly preferred as Reactant 1 are hexamethylene diisocyanate homopolymers commercially available, for instance as DESMODUR N-100 from Lanxess Corp., Pittsburgh Pa.

Also suitable for use as Reactant 1 are hydrocarbon diusocyanate-derived isocyanurate trimers. Preferred is DESMODUR N-3300 (a hexamethylene diisocyanate-based isocyanurate). Other triisocyanates useful for the purposes of this invention are those obtained by reacting three moles of toluene diisocyanate with 1,1,1-tris-(hydroxymethyl)ethane or 1,1,1-tris-(hydroxymethyl)propane. The isocyanurate trimer of toluene diisocyanate and that of 3-isocyanatomethyl-3,4,4-trimethylcyclohexyl isocyanate are other examples of triisocyanates useful for the purposes of this invention, as is methine-tris-(phenylisocyanate). Precursors of polyisocyanate, such as diisocyanate, are also suitable for use in the present invention as substrates for the polyisocyanates.

The fluorocarbon alcohol, fluorocarbon thiol, or fluorocarbon amine (Reactant 2) suitable for use in the present invention has the structure:
R_{f}-X—Y—H
wherein

R_{f} is a C₄-C₂₀ linear or branched fluorocarbon chain,

X is a divalent linking radical of formula —(CH₂)ₚ or —SO₂N(R₁)—CH₂CH₂—, wherein p is 1 to about 20; and R₁ is an alkyl of 1 to about 4 carbon atoms; and

Y is —O—, —S—, or —N(R₂)— where R₂ is H or R₁.

More particularly R_{f} is C_{q}F_{(2q+1)} wherein q is 4 to about 20, or mixtures thereof. Preferred examples of R_{f}—X— include the following: 1) mixtures of F(CF₂)_{q}(CH₂)ₙ— wherein q is as previously defined and n is 1 to about 20, and 2) F(CF₂)_{q}SO₂N(R₁)CH₂CH₂— wherein q and R₁ are as previously defined. An example of mixture 1) includes the group of formula F(CF₂CF₂)nCH₂CH₂OH, wherein n has values selected from 2, 3, 4, 5, 6, 7, 8, 9, and 10, said fluorochemical compounds being present in the proportions shown as compositions (i) or (ii):

TABLE 1

Composition
by weight %

| N | (i) | (ii) |
|---|---|---|
| 2 | 0-3 | |
| 3 | 27-37 | 0-3 |
| 4 | 28-32 | 45-52 |
| 5 | 14-20 | 26-32 |
| 6 | 8-13 | 10-14 |
| 7 | 3-6 | 2-5 |
| 8 | 0-2 | 0-2 |
| 9 | 0-1 | 0-1 |
| 10 | 0-1 | 0-1 |

The alcohol, amine, or thiol reactant suitable for use herein is a straight chain or a branched alcohol, a straight chain or branched amine, or a straight chain or branched thiol. Primary alcohols are preferred since such alcohols are more readily reacted with the isocynate groups than secondary or tertiary alcohols for steric reasons. Reactant 3 is a branched alcohol, amine, or thiol, or a mixture of branched and straight chain alcohols, amines, or thiols. Utilizing a proportion of branched chain alcohols, amines, or thiols provides a softer finish, probably by adding to the chain disorder. While the molar ratio of branched chain alcohol, amine, or thiol to straight chain alcohol, amine, or thiol is quiet broad, the molar ratio of branched chain to straight chain is preferably in the range 100:0 to 40:60.

Suitable straight chain alcohols, amines, or thiols have the structure H(CH₂)ₓ—OH, H(CH₂)ₓ—NH₂, or H(CH₂)ₓ—SH, wherein x is 12 to 20 and preferably 16 to 18, or mixtures thereof. Particularly preferred is the readily available stearyl alcohol (1-octadecanol) having x=18. Optionally, ethoxylates of alcohols may be used.

Suitable branched chain alcohols, amines, or thiols have the structure C_{y}H_{(2y+1)}—CH₂—OH, C_{y}H_{(2y+1)}—CH₂—NH₂, or C_{y}H_{(2y+1)}—CH₂—SH wherein y is in the range 15 to 19, or mixtures thereof. An example is ISOFOL 18T, a mixture of branched chain alcohols comprising 2-hexyl- and 2-octyl-decanol, and 2-hexyl- and 2-octyl-dodecanol, available from Sasol North America, Inc., Houston Tex. Optionally, ethoxylates of alcohols may be used.

The reactant comprising the alcohol containing a sulfonic acid group or its salt (Reactant 4) contributes anionic sites to the product polymer, such that the polymer has self-dispersing properties and forms stable aqueous dispersions without added surfactants. The alcohol-sulfonate salt has the structure
MO₃S—W—OH
wherein

M is an alkali metal; ammonium; alkyl, dialkyl, trialkyl, or tetraalkyl ammonium; or hydrogen; and W is a straight or branched chain alkyl group containing from about 2 to about 10 carbon atoms, or an aryl or alkylaryl group containing one or more aromatic rings and 6 to about 11 carbon atoms.

Preferred is sodium 2-hydroxyethyl sulfonate, commercially available under the trivial name sodium isethionate. Other examples of such hydroxysulfonic acids are ammonium isethionate, 3-hydroxy-1-propanesulfonic acid and its sodium salt, 4-hydroxybenzene sulfonic acid and its sodium salt, sodium 4-hydroxy-1-naphthalene sulfonate, and sodium 6-hydroxy-2-naphthalene sulfonate.

The alcohol containing a sulfonic acid group or its salt (Reactant 4) is not necessarily fully incorporated into the polyurethane. Thus the amount of the alcohol containing a sulfonic acid group or its salt may be slightly lower than the amount added and the amount of crosslinking by the linking reagent will be higher.

The sulfonic acid groups or their salts used as Reactant 4 are advantageous over the sulfates used in the prior art. The sulfates are hydrolyzed at the low pH ranges used in leather treatments, while the sulfonates are not hydrolyzed at these pH ranges.

If reactants 1 to 4 are not present in sufficient quantities to consume all of the isocyanate groups, the remaining isocyanate groups are reacted with a multi-functional linking agent (Reactant 5), thereby linking two or more isocyanate-terminated molecules together and increasing the molecular weight of the product. Typically, a compound containing a hydroxy group is used as the linking agent. While water is the most commonly used linking agent, other multi-functional compounds such as glycols are also suitable for use herein. When a linking agent other than water is selected, a stoichiometric insufficiency is used, as discussed below. A fluorinated diol is also suitable for use herein, such as the structure.
(HO—CH₂)₂C(CH₂—S—[CH₂]₂-C₈F17)₂

Such a fluorinated diol, clearly, acts a both a linking agent (Reactant 5) and as a fluorocarbon alcohol (Reactant 2). An example of such a diol is LODYNE 941, available from Ciba Specialty Chemicals, High Point N.C.

The fluorinated urethanes used in the present invention are prepared in a suitable dry solvent free of groups that react with isocyanate groups. Organic solvents are employed. Ketones are the preferred solvents, and methylisobutylketone (MIBK) is particularly preferred for convenience and availability. A small proportion of a solubilizing aid such as dimethylformamide, dimethylacetamide, or N-methylpyrrolidone (e.g., 10% of the solvent) increases the solubility of the sodium hydroxysulfonate and is optionally used if incorporation of the hydroxysulfonate is too slow or is incomplete. The reaction of the alcohols with the polyisocyanate is optionally carried out in the presence of a catalyst, such as dibutyltindilaurate or tetraisopropyltitanate, typically in an amount of about 0.1-1.0%. A preferred catalyst is dibutyltindilaurate.

The ratio of reactants on a molar basis per 100 isocyanate groups is shown in Table 2 below:

TABLE 2
Reactant Ratios (as mole % based on total available isocyanate
groups in Reactant 1)

| | Mole % Ratio Ranges | | | |
|---|---|---|---|---|
| | Broad | | Preferred | |
| Reactant | From | To | From | To |
| Fluoroalcohol or fluorothiol (Reactant 2) | 28 | 48 | 33 | 43 |
| Alcohol, amine, or thiol (Reactant 3) | 28 | 48 | 33 | 43 |
| Hydroxysulfonic acid or salt thereof (Reactant | 1 | 20 | 3 | 5 |
| 4) | | | | |
| Total reactants less linking agent | 70 | 100 | 75 | 85 |

Thus the linking agent is 0 to 30, preferably 15 to 25. The ratio of straight and branched alcohols, amines, or thiols is as previously specified above in the description of Reactant 3.

Since the equivalent weights of Reactants 1-4 vary according to the specific reactants chosen, the amounts are necessarily calculated in molar ratios. Examples of specific polymer compositions showing weight ratios are shown in Table 3 using the various fluoroalcohol homologue distributions shown in Table 4

TABLE 3
Weight Proportions of Polymer Reactants

| | | | |
|---|---|---|---|
| | Case 1 | Case 2 | Case 3 |
| Component | g (mole %) | g (mole %) | g (mole %) |

Reactant 1, 62.7 g DESMODUR N-100 with 21.1% —NCO in each Case.

| | | | |
|---|---|---|---|
| Reactant 2, Fluoroalcohol | | | |
| as Distribution 1 in Table 3 | 61.87 (40) | 58.78 (38) | 46.40 (30) |
| below, or | | | |
| as Distribution 2 in Table 3 | 56.17 (40) | 53.37 (38) | 42.13 (30) |
| below, or | | | |
| as Distribution 3 in Table 3 | 67.01 (40) | 63.65 (38) | 50.25 (30) |
| below | | | |
| Reactant 3, Hydrocarbon | 23.88 (28) | 32.40 (38) | 39.22 (46) |
| Alcohols | | | |
| Reactant 4, Isethionic Acid | 0.93 (2) | 1.87 (4) | 9.34 (20) |
| Molar Total, Reactants 2-4 | (70) | (80) | (96) |

TABLE 4
Weight Distributions and Equivalent Weights of Fluoroalcohols
of Formula F—(CF₂—CF₂)ₙ—CH₂—CH₂—OH used in Table 3

| N | Distribution 1 | Distribution 2 | Distribution 3 |
|---|---|---|---|
| 2 | 0.43 | 0.76 | — |
| 3 | 32.46 | 47.38 | 1.92 |
| 4 | 31.86 | 30.92 | 51.93 |
| 5 | 19.23 | 14.00 | 29.34 |
| 6 | 9.86 | 4.96 | 12.08 |
| 7 | 4.11 | 1.55 | 3.45 |
| 8 | 1.55 | 0.38 | 1.04 |
| 9 | 0.48 | 0.05 | 0.24 |

Effective Fluoroalcohol Equivalent Weight

| | | |
|---|---|---|
| 490.7 | 445.5 | 531.4 |

Fluorinated esters suitable for use in the present invention include alkylated fluorochemical oligomeric and polymeric compounds comprising an oligomer or polymer having a fluoroaliphatic pendant group and optionally fluorine-free aliphatic and optionally polyoxyalkylene pendant groups. Said oligomeric or polymeric compounds are linked through a linking group to an aliphatic moiety having at least 8 and preferably at least 12 carbon atoms, and having the structure of Formula 1 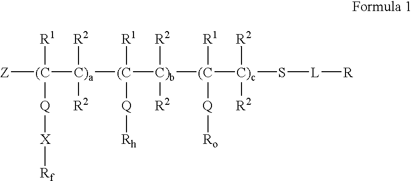
wherein:

Z is a hydrogen atom or a group derived from a free radical initiator;

a is a positive integer and at least 4;

b and c are independently zero or a positive integer;

the sum (a+b+c) is a number such that the molecular weight is less than 1,000,000 and preferably less than 200,000;

each R¹ is independently hydrogen, halogen, or straight chain or branched chain alkyl containing 1 to about 4 carbon atoms;

each R² is independently hydrogen or straight chain or branched chain alkyl containing 1 to about 4 carbon atoms;

X is a divalent linking radical of formula —(CH₂)ₚ or —SO₂N(R₁)CH₂CH₂—, wherein p is 1 to about 20; and R₁ is an alkyl of 1 to about 4 carbon atoms;

each Q is independently a covalent bond or an organic linking group selected from straight chain or branched chain or cyclic alkylene, arylene, aralkylene; oxy, thio, sulfonyl, sulfoxy, amino, imino, sulfonamido, carboxamido, carbonyloxy, urethanylene, urylene, and combinations thereof such as sulfonamidoalkylene group;

S is a sulfur atom;

R is a saturated or unsaturated aliphatic moiety of at least 8 and preferably at least 12 carbon atoms;

R_{f} is a C₄-C₂₀ linear or branched fluorocarbon chain;

Rₕ is a fluorine-free aliphatic group, preferably having 18 or fewer carbon atoms;

Rₒ is a polyoxyalkylene group; and

L is a linking group which is a covalent bond, straight chain or branched chain or cyclic alkylene, arylene, aralkylene, oxy, sulfonyl, sulfoxy, amino, imino, sulfonamido, carboxamido, carbonyloxy, urethanylene, ureylene, and combinations thereof.

The linking group L may result from a condensation reaction between a nucleophile, such as an alcohol, an amine, or a thiol, and an electrophile such as a carboxylic acid, ester, acyl halide, sulfonate ester, sulfonyl halide, cyanate, isocyanate, or may result from a nucleophilic displacement reaction between a nucleophile and a moiety bearing a leaving group, such as the reaction between an alcohol (or alkoxide) and an alkyl halide (where the halogen atom of the alkyl halide serves as a leaving group).

The fluoroaliphatic group R_{f}, the fluorine-free aliphatic group Rh and the polyoxyalkylene group Rₒ are each linked to the oligomeric or polymeric backbone or the unsaturated portion of the monomer used in making the oligomer or polymer by linking groups designated as Q in the Formula 1. Each Q is independently a linking group that may be a covalent bond, divalent alkylene, or a group that can result from the condensation reaction of a nucleophile such as an alcohol, an amine, or a thiol with an electrophile, such as an ester, acid halide, isocyanate, sulfonyl halide, sulfonyl ester, or may result from a displacement reaction between a nucleophile and leaving group. Each Q is independently chosen and preferably contains from 1 to about 20 carbon atoms and can optionally contain oxygen, nitrogen, sulfur, or silicon-containing groups or a combination thereof. Q is preferably free of functional groups that substantially interfere with free-radical oligomerization (e.g., polymerizable olefinic double bonds, thiols, easily abstracted hydrogen atoms such as cumyl hydrogens, and other such functionality known to those skilled in the art).

Z is a group derived from a free-radical initiator. As used herein, the term “free-radical initiator” designates any of the conventional compounds such as organic azo compounds, organic peroxides (e.g., diacyl peroxides, peroxyesters, dialkyl peroxides) and the like that provide initiating radicals upon homolysis. As used herein, the term “group derived from a free-radical initiator” designates an initiating radical formed upon homolytic decomposition of a free-radical initiator.

The molecular weight of the fluorinated ester ranges up to about 1,000,000. Preferred are molecular weights of up to about 200,000. Molecular weights in excess of 200,000 progressively increase synthesis and application difficulties, and are thus progressively less preferred.

The fluorinated urethanes and fluorinated esters are typically used in the present invention in the form of a dispersion or emulsion containing from about 5% to about 45% solids in the dispersion or emulsion. Preparation of such dispersions or emulsions is well known to those skilled in the art.

Fluorinated citrate urethanes suitable for use in combination with fluorinated urethanes and/or fluorinated esters in the present invention are described by Raynolds et al. in U.S. Pat. No. 4,595,518. Generally such fluorinated citrate urethanes are prepared by contacting a fluorocarbon alcohol, or mixture thereof, with citric acid, and then with at least one diisocyanate, polyisocyanate, or mixture of diisocyanates and/or polyisocyanates. A mixture of fluoroalkyl alcohols is used to prepare a mixture of fluorinated citrates. The fluoroalkyl alcohol mixture is heated and agitated with anhydrous citric acid. Esterification catalysts such as granular boric acid and aqueous phosphorous acid are employed. Water, eliminated in the esterification reaction, is removed by distillation or other suitable means until the analysis indicates the reaction is complete. The resulting ester is reacted with a diisocyanate, polyisocyanate, or mixture of polyisocyanates in the presence of a catalyst such as butyltintrichloride. After completion of the reaction, a solvent such as methylisobutylketone is added to give a solution of the fluorinated citrate urethane in the solvent. The fluorinated citrate urethane can be dispersed in water by conventional means.

The fluorinated citrate urethanes are also used in the present invention in the form of an aqueous dispersion, typically containing from about 35% to about 45% of the solid citrate urethane in the dispersion.

In the mixtures of dispersions of fluorinated urethanes, fluorinated esters, and fluorinated citrate urethanes as used in the practice of the present invention, the weight ratio of the urethane or ester dispersion to the citrate urethane dispersion is from about 1:0 to about 1:1.5, and preferably from about 1:0.6 to about 1:1.2.

The fluorinated additives used in the present invention can be used with any tanning process to make washable leather. For example, Scheen's tanning process, taught in U.S. Pat. No. 5,972,037, started with pretreated hides, i.e., with hides that had been cured, freed of flesh and excess hair, and treated by chrome tanning or an equivalent process. Such tanned hides are referred to in the industry as pelts or wet blue hides, and the term “wet blue hide stage” is used herein to describe this stage in the overall tanning process. In Scheen's process, the wet blue hides were washed and rinsed in lukewarm water to remove chemicals with which the hides had previously been treated. The next steps were buffering and character-building steps that equalized the pH of the leather and built desired characteristics such as suppleness into the hides. Retanning of the hides was continued by treating them with additional character builders to enhance and impart additional desirable characteristics. The hides were then washed, drained, and re-immersed in water (“floated”) at a mildly elevated temperature to substitute a softening agent for fat removed from the pores of the hides in a previous process step or steps. In a typical application the refloat step was followed by treatment in a water-based solution, including dispersions, colloidal suspensions, and the like, as well as true solutions, of additional softening agents to optimize the feel of the leather, and a dyeing step to impart the wanted color to the leather. Steps to fix the previously added chemical or additives in place in the leather and refloatation with a hydrophobic waterproofing agent followed this. These steps were followed by buffering for pH equalization and increase of the pH to an appropriate level. Then, the hides were washed, rinsed, and treated with an additive selected to impart a silky feel to the leather into which the hides were being converted. Scheen next provided treatment with a hydrophobic silicone to promote waterproofing and washability; a second fixing step; and a final rinse of the processed hides. The term “additive addition stage” is used herein to describe the point in Scheen's process where the silicone (the hydrophobe) additive was introduced. For other tanning processes, the additive addition stage is prior to final rinsing and drying.

In the method of the present invention, the fluorinated additive, in the form of an aqueous emulsion or dispersion is added during tanning of the leather at any suitable stage. It is preferably added to the float at the additive addition stage of the tanning process. In the Scheen process, the fluorinated additive preferably replaces the hydrophobic silicone additive.

The fluorinated hydrophobic additives used in the present invention provide durable stain release during washing or laundering of the washable leather. The fluorinated additives used in the present invention also provide durable oil repellency and durable and enhanced water repellency.

The fluorinated additive dispersions are added to the tanning bath in an amount sufficient to provide a fluorine content in the dried leather of at least 0.2 g fluorine/m², preferably at least 0.5 g fluorine/m², more preferably at least 1.0 g fluorine/m², and more preferably at least 2.0 fluorine/m². Costs increase with higher fluorine levels without significant additional benefit beyond about 10 g fluorine/m².

In practice, the amount of the fluorinated additive dispersion added to the bath at the additive addition stage is from about 1% to about 12% by weight based on the weight of the wet blue hide. The fluorinated additive dispersions typically contain 10% to 30% fluorinated components.

The bath conditions for impregnating the leather with the fluorinated additives of the present invention preferably maintain control over pH, temperature, and the time that the wet blue hide is in the bath. Bath temperature and duration of immersion are inter-related, and techniques to balance these are well known to those skilled in the art. The pH is from about 2.5 to about 4.0 and preferably from about 3.0 to about 3.5. The bath temperature is from about 30° C. to about 70° C., and preferably from about 50° C. to about 60° C. After the fluorinated additive is added to the float in the tanning bath at the additive addition stage, tumbling of the hides in the process solution is continued for a period of from about 5 to about 90 min., typically for about 15 to about 45 min. and most commonly for about 15 min. The formic acid or other fixing agent is then added to the float, preferably in three equal portions and typically at 5-10 minute intervals. Tumbling of the hides in the tanning bath is continued for a period of 15 to 30 min. and typically 15 minutes after the fixative is added to the float solution.

Leather is based on hides that are natural products and therefore a variable substrate. Methods to adjust bath conditions and concentration to accommodate such natural variations are well known to those skilled in the art.

The tanning process is completed according to the process of the previously cited U.S. Pat. No. 5,972,037 by draining the float solution from the tanning bath; washing the hides in room temperature water until clean to remove excess chemicals; and drying the clean hides. The process improvement requires only a single drying step and no post-tanning treatment of the leather. The product leather is washable, has both durable oil- and water-repellency, and has durable stain release.

Leathers are commonly dyed. Dyes added to the tanning process do not affect the durable oil repellency, durable stain release, and durable water repellency properties of the present invention. The leather color may affect the perception of staining, for instance on off-white versus black leather, so the color of samples is noted in the tables in the examples herein and comparisons are best made between leathers of the same color.

The present invention further comprises washable leather having durable oil repellency, durable stain release, and durable water repellency. Such leather is prepared by the method described above. The washable leather has a fluorine content in the dried leather of at least 0.2 g fluorine/m², preferably at least 0.5 g fluorine/m², more preferably at least 1.0 g fluorine/m², and more preferably at least 2.0 fluorine/m². The fluorinated additive as described above used in the present invention penetrates the leather and provides an unexpected level of oil and water repellency accompanied by durable stain release while maintaining the soft hand or feel of the finished leather. The penetration of the fluorinated additive into the leather enables the durable oil- and water-repellency and durable stain release properties of the leather to survive scuffing. Further, these properties are obtained while maintaining the washability of the leather. Thus, use of household washing and drying appliances can be used to clean the washable leather, while maintaining its desired characteristics and while maintaining the durable oil repellency, durable stain release, and durable water repellency provided by the present invention. The washable leather of the present invention is useful in a variety of consumer products, including but not limited to, apparel, gloves, footwear, furniture, accessories and other applications where leather is typically employed.

### MATERIALS AND TEST METHODS

Commercially available split pigskin suede wet blue hides were used throughout the examples to make washable leathers.

The silicone used in Comparative Examples was DENSODRIN S, available from Clariant Corp., Fair Lawn N.J.

Fluorinated Additive 1 was a dispersion of a fluorinated urethane, prepared according to Example 1.

Fluorinated Additive 2 was a mixture a fluorinated urethane and a fluorinated citrate urethane, prepared according to Example 2.

Test methods 1-3 are intended to measure the intrinsic repellency of the substrate surface and not to simulate actual wear performance in the field.

Test Method 1—Measurement of Dynamic Water Repellency (Spray Test)

Dynamic water repellency was measured according to the American Association of Textile Chemists and Colorists (AATCC) TM-22. Samples are visually scored by reference to published standards, with a rating of 100 denoting no water penetration or surface adhesion. A rating of 90 denotes slight random sticking or wetting without penetration; lower values indicate progressively greater wetting and penetration. Test Method 1, the dynamic water repellency test, is a more demanding and realistic test of water repellency than Test Method 2, the drop or static test.

Test Method 2—Measurement of Static Water Repellency (Drop Test)

Drops of standard test liquids are placed on the substrate surface and observed for wetting and contact angle. The compositions of the aqueous test liquids are shown in table below. The water repellency rating is the highest-numbered test liquid that does not wet the substrate surface using the evaluation methods above.

Beginning with the lowest-numbered test liquid, 3 small drops are placed on the substrate surface in several locations. The drops are observed for 10 seconds from approximately a 45° angle. If the water does not wet the substrate around the edge of the drop and the drop maintains the same contact angle, a drop of the next higher-numbered test liquid is placed at an adjacent site on the substrate and again observed for 10 seconds.

This procedure is continued until one of the test liquids shows obvious wetting of the substrate under or around the drop within 10 seconds, or until the drop fails to maintain the same contact angle between the substrate surface and the drop. The water repellency rating of the substrate is the highest-numbered test liquid that will not wet the substrate within a period of 10 seconds. Two of three drops satisfying the above criteria constitutes a “pass.”

Higher ratings indicate increasing water repellency.

TABLE 5
Water Repellency Test Liquids (Water Drop Rating)

| Test Solution # | Water/Isopropanol ratio* |
|---|---|
| 1 | 98/2 |
| 2 | 95/5 |
| 3 | 90/10 |
| 4 | 80/20 |
| 5 | 70/30 |
| 6 | 60/40 |
| 7 | 50/50 |
| 8 | 40/60 |
| 9 | 30/70 |
| 10 | 20/80 |
| 11 | 10/90 |
| 12 | 0/100 |

*% by volume

Test Method 3—Oil Repellency

Oil repellency testing was performed according to the American Association of Textile Chemists and Colorists Test AATCC TM-118.

Higher ratings indicate increasing oil repellency. A rating of zero means no oil repellency.

Test Method 4—Stain Release

The procedure described in the American Association of Textile Chemists and Colorists AATCC TM-130 was used, except that in place of oily stains, water-based FRENCH'S YELLOW MUSTARD was used as the staining agent. Higher ratings represent better stain release. The difference between a 5 rating and a 4 rating is clearly visible to the naked eye.

### EXAMPLES

### Example 1

A flask was charged with 99.98 g of a solution of 62.7% by weight DESMODUR N-100 (a hexamethylene diisocyanate prepolymer available from Lanxess Corporation, Pittsburgh Pa.) in methyl isobutylketone, MIBK, (calculated 320 mmol -NCO), 1.94 g isethionic acid (13 mmol), 16.77 g stearyl alcohol (61 mmol), 16.76 g ISOFOL 18T (61 mmol, available from Sasol North America, Inc., Houston Tex.), and 57.68 g mixed 1,1,2,2-tetrahydroperfluoro-1-alkanols, predominately C8, C10, C12, and C14 with small amounts of C6, C16, and C18 (available from E. I. Du Pont de Nemours and Company, Wilmington Del., 122 mmol). With stirring, this mass was heated to 48° C. and a solution of approximately 0.027 g dibutyltindilaurate in 1-2 mL of MIBK was added to the flask. The temperature of the reaction spontaneously rose to 76° C. from the heat of reaction. The reaction mass was then further heated to 130° C. and maintained at that temperature for 21-22 hours. After the addition of 2.33 g of deionized water to consume the remaining isocyanate functional groups and 104.41 g of MIBK, the reaction mass was held at 75° C. for 3 hours. This initial product was then emulsified with 408.15 g of deionized water, and the MIBK and some of the water was removed by distillation to give 477 g of a dispersion product that was determined to be 29.9% solids. This dispersion is designated herein as Fluorinated Additive 1.

### Example 2

A mixture of 2-perfluoroalkylethanols was used to prepare a mixture of tris(2-perfluoroalkylethyl) citrates. The mixture of 2-perfluoroalkylethanols was such that in their perfluoroalkyl groups, CF₃CF₂(CF₂)ₖ, where k was 2, 4, 6, 8, 10, 12 and 14 in the approximate weight ratio of 1/33/31/18/8/3/1, and such a mixture had an average molecular weight of about 452. The 2-perfluoroalkylethanol (4306 kg) was combined with agitation at 70° +/−5° C. with anhydrous citric acid (562 kg). Thereafter granular boric acid (2.7 kg) and aqueous phosphorous acid (6.4 kg of a 70% solution) were added as catalysts. The temperature of the reaction mixture was increased over a 3-4 h period to 130° +/−5° C. with agitation. Agitation was continued for 23-24 h while removing water formed in the reaction between the 2-perfluoroalkylethanol and citric acid. When analysis indicated that the esterification was complete, the temperature of the reaction was reduced to 70°-80° C. and butyltintrichloride (5.9 kg) was added. The temperature was adjusted to 70°-75° C. and hexamethylene diisocyanate (255 kg) was added. The temperature was allowed to rise to 80°-86° C. and held at that temperature for about 6 h. Thereafter the temperature was increased to 92° +/−2° C. and the reaction mixture agitated at that temperature for 8 h. The reaction temperature was then reduced to 55°-75° C. and methylisobutylketone (2312 kg) was added to it. The reaction temperature was adjusted to 60°-70° C. and the mixture was agitated for 1-2 h. The product was a solution of the tris(2-perfluoroalkylethyl) citrate urethane in methylisobutylketone having a weight of 7003 kg which contained 4392 kg of a mixture of tris(2-perfluoroalkylethyl) citrate urethanes.

A mixture of tris(2-perfluoroalkylethyl) citrate urethanes (851 kg), prepared as above, were dissolved in methylisobutylketone (419 kg) prepared in the manner described above was emulsified with deionized water (1419 kg) and aqueous sodium dodecylbenzene sulfonate (85 kg of a 30% solution). The methylisobutylketone was then removed from the emulsion by vacuum distillation. The resulting dispersion was standardized to 40 +/−1.5% of the citrate urethane, using deionized water.

This dispersion was mixed with the dispersion of Example 1 and the mixture is designated herein as Fluorinated Additive 2.

### Example 3

The tanning process was followed from the wet blue hide stage as described above and in U.S. Pat. No. 5,972,037. Wet blue hides were washed and rinsed. They were then immersed in a water float of 100% to 150% of wet blue weight and 1% by weight of the wet blue hide of sodium formate, and 0.75% by weight of the wet blue hide of sodium acetate were added as buffering agents. After buffering the hides were washed drained and refloated in water with at least 100% to 150% of wet blue hide weight. Then 6% by weight of the wet blue hide of TERGOTAN MC-N, and 4% by weight of wet blue hide of TERGOTAN EFB, each available from Clariant Corporation, Fair Lawn, N.J., were added as character builder agents to help build suppleness into the leather. After the hides were again drained washed, and refloated as previously, 4% by weight of the wet blue hides of DERMALIX C (also available from Clariant Corp.) was added as a softening agent. Dye was then added to achieve the desired color in the finished leather. This was followed by a fixing agent (formic acid) and retanning (chrome agents). After again draining, washing and refloating at a lower weight by tannage of 75%,OMBROPHOB M available from Clariant Corp. (10% by weight of the wet blue hide) was added as a waterproofing agent. After draining, washing and refloating to 100% to 150% of wet blue weight, the bath was then treated with 4% of a fluorinated additive dispersion based on the wet blue hide weight. The fluorinated dispersion was Fluorinated Additive 2. The pH was lowered to 3-3.5 with formic acid for fixation. The hides were finished conventionally by rinsing, pulling from the drum and drying at ambient temperatures. Oil and water repellencies were determined using Test Methods 1, 2, and 3. The results are shown in Table 6 below.

### Examples 4-7

The procedure of Example 3 was followed except that 4% of Fluorinated Additive 1 was added to the bath, based on the wet blue hide weight. Oil and water repellencies were determined using Test Methods 1, 2, and 3. The results are shown in Table 6 below.

### Comparative Examples A1-A7

Conventional non-washable split pigskin suede leather samples were obtained from Atlas Refinery, Inc., Newark, N.J. During tanning and prior to the final rinsing and drying steps, the leather samples were treated in a bath with 4% of a dispersion of one of the two fluorinated additives described in Examples 1 and 2, based on the wet blue hide weight. Comparative Examples A1 and A2 used Fluorinated Additive 2. Comparative examples A3-A7 used Fluorinated Additive 1. The pH was lowered to 3.1-3.3 with formic acid for fixation. The hides were finished conventionally to yield conventional (non-washable) split pigskin suede. Oil and water repellencies were determined using Test Methods 1, 2, and 3. The results are shown in Table 6 below.

### Comparative Examples B1-B14

Samples of washable leather were obtained from Jintex, Taipei, Taiwan. During tanning and prior to the final rinsing and drying steps, the leather samples were treated in a bath with 4% of a dispersion of one of the two fluorinated additives described in Example 1 and 2, based on the wet blue hide weight. Comparative Examples B1-B4 used Fluorinated Additive 2. Comparative Examples B5-B14 used Fluorinated Additive 1. The hides were finished conventionally to yield leather samples used for testing. Oil and water repellencies were determined using Test Methods 1, 2, and 3. The results are shown in Table 6 below.

TABLE 6

| | | | | |
|---|---|---|---|---|
| | | Spray | | |
| | | (dynamic) | | |
| | | Re- | Water | Oil |
| | | pellency | Repellency | Repellency |
| Example | Color | TM1** | TM2** | TM3** |

Fluorinated Additive 1

| | | | | |
|---|---|---|---|---|
| 4 | Brown | 90 | 6 | 5 |
| 5 | Tan | 100 | 8 | 6 |
| 6 | Tan | 100 | 7 | 6 |
| 7 | Brown | 100 | 6* | 5 |
| Comparative Ex. A3 | Tan | 50 | 4 | 2 |
| Comparative Ex. A4 | Tan | 50 | 4 | 2 |
| Comparative Ex. A5 | Tan | 70 | 5 | 4 |
| Comparative Ex. A6 | Tan | 70 | 4 | 2 |
| Comparative Ex. A7 | Tan | 70 | 4 | 2 |
| Comparative Ex. B5 | Black | 80 | 5 | 1 |
| Comparative Ex. B6 | Tan | 90 | 5 | 2 |
| Comparative Ex. B7 | Tan | 70 | 5 | 2 |
| Comparative Ex. B8 | Tan | 90 | 5 | 2 |
| Comparative Ex. B9 | Black | 80 | 5 | 1 |
| Comparative Ex. B10 | Black | 80 | 4 | 1 |
| Comparative Ex. B11 | Black | 70 | 5 | 1 |
| Comparative Ex. B12 | Black | 80 | 5 | 1 |
| Comparative Ex. B13 | Tan | 70 | 5 | 1 |
| Comparative Ex. B14 | Tan | 80 | 5 | 2 |

Fluorinated Additive 2

| | | | | |
|---|---|---|---|---|
| 3 | Brown | 90 | 6 | 6 |
| Comparative Ex. A1 | Tan | Not tested | 5 | 5 |
| Comparative Ex. A2 | Tan | Not tested | 4 | 4 |
| Comparative Ex. B1 | Black | 80 | 5 | 2 |
| Comparative Ex. B2 | Black | 80 | 5 | 2 |
| Comparative Ex. B3 | Black | 70 | 5 | 2 |
| Comparative Ex. B4 | Black | 80 | 5 | 1 |

Fluorinated Additives 1 and 2, see Materials above
*not tested beyond “6”
**TM 1 indicates the use of Test Method 1, TM 2 indicates the use of Test Method 2, and TM 3 indicates use of Test Method 3.

Table 6 shows leather of Examples 3-7 treated with Fluorinated Additive 1 or Fluorinated Additive 2 exhibited much improved dynamic water repellency (on average >90) compared to values around 80 and below for the Comparative Examples A1-A7 and B1-B14. Furthermore, static repellency was superior in Examples 3-7 to that in the Comparative Examples. In particular, leather of Examples 3-7 treated with Fluorinated Additive 1 or Fluorinated Additive 2 showed very high oil repellency (values >5) compared with values of 4 or less for the Comparative Examples. Static water repellency was enhanced by one or two units in Examples 3-7 when the leather was treated with Fluorinated Additive 1 or Fluorinated Additive 2 compared to the Comparative Examples. This demonstrated a synergistic effect of use of the fluorinated additives with leather tanned using the process of U.S. Pat. No. 5,972,037 compared to other tanning processes.

### Comparative Examples C1, C2, and D₁-D4.

Comparative Example C1 was prepared by the method as described in U.S. Pat. No. 5,972,037 using a commercially available silicone hydrophobe at 4% of wet blue hide weight (DENSODRIN S, see Materials). Comparative Example C2 was also prepared by this method, but without the addition of the silicone hydrophobe. Samples for Comparative Examples D1-D4 were commercially available washable leather not treated with fluorinated additive, and were obtained from AMI of San Francisco, Calif. Comparison of performance of Examples 3-7 vs. Comparative Examples C1, C2, and D1-D4 are presented in Table 7.

TABLE 7

| | | | Spray | | |
|---|---|---|---|---|---|
| | | | (dynamic) | Water | Oil |
| | Fluorinated | | Repellency | Repellency | Repellency |
| Ex. | Additive | Color | TM1** | TM2** | TM3** |
| 3 | 2 | Brown | 90 | 6 | 6 |
| 4 | 1 | Brown | 90 | 6 | 5 |
| 5 | 1 | Tan | 100 | 8 | 6 |
| 6 | 1 | Tan | 100 | 7 | 6 |
| 7 | 1 | Brown | 100 | 6* | 5 |

Non-fluorinated Additive (Comparative Examples)

| | | | | | |
|---|---|---|---|---|---|
| C1 | Silicone | Tan | 80 | 4 | 0 |
| C2 | None | Tan | 80 | 4 | 0 |
| D1 | None | Pink | <50 | 3 | 0 |
| D2 | None | Tan | <50 | 3 | 0 |
| D3 | None | Off-White | 0 | 2 | 0 |
| D4 | None | Light | <50 | 3 | 0 |
| | | Green | | | |

Ex = Example
Fluorinated Additives 1 and 2 and Silicone, see Materials above.
*not tested beyond “6”
**TM 1 indicates the use of Test Method 1, TM 2 indicates the use of Test Method 2, TM 3 indicates the use of Test Method 3.

Table 7 shows treating the leather with Fluorinated Additive 1 or 2 enhances both static and dynamic repellency properties. Performance of Examples 3-7 displayed very high oil repellency levels while Comparative Examples C1, C2, and D1-D4 were not repellent. Water repellency was much improved both from a dynamic and static standpoint. In the dynamic repellency test, there are significant differences between ratings of 80, 90, and 100.

### Example 8

The leather of Examples 3-7 was machine washed on gentle cycle with cold water and WOOLITE detergent (from Boyle-Midway, Inc., New York N.Y.). After tumble-drying on low heat, the samples were re-evaluated for their repellency performance. The results are presented in Table 8.

TABLE 8

| | | | Spray (dynamic) | | | | Water Repellency, | | | | Oil Repellency, | | | |
|---|---|---|---|---|---|---|---|---|---|---|---|---|---|---|
| | | | Repellency, TM1** | | | | TM2** | | | | TM3** | | | |
| | Fluorinated | | After washes (a) | | | | After washes (a) | | | | After washes (a) | | | |
| Ex. | Additive | Color | 0 | 1 | 2 | 3 | 0 | 1 | 2 | 3 | 0 | 1 | 2 | 3 |
| 3 | 2 | Brown | 90 | 90 | 90 | 80 | 6 | 8 | 6 | 8 | 6 | 6 | 6 | 6 |
| 4 | 1 | Brown | 90 | 80 | 80 | 80 | 6 | 8 | 6 | 6 | 5 | 5 | 5 | 5 |
| 5 | 1 | Tan | 100 | 100 | 100 | 100 | 8 | 8 | 7 | 7 | 6 | 6 | 5 | 6 |
| 6 | 1 | Tan | 100 | 100 | 100 | 90 | 7 | 7 | 6 | 7 | 6 | 5 | 5 | 6 |
| 7 | 1 | Brown | 100 | NT | NT | NT | 6* | 6* | NT | 4 | 5 | 6* | NT | 2 |

Ex = Example
Fluorinated Additives 1 and 2, see Materials above.
(a) Zero washes indicates initial sample before first wash.
NT indicates “not tested”.
*not tested beyond “6”
**TM 1 indicates the use of Test Method 1, TM 2 indicates the use of Test Method 2, TM 3 indicates the use of Test Method 3.

Table 8 shows the high static and dynamic repellency ratings achieved by treating the leather of Examples 3-7 with Fluorinated Additive 1 or 2 was maintained even after three laundry cycles thus demonstrating the durability of these properties.

### Example 9

Leather samples, prepared as described above in Examples 3-6 and Comparative Examples C1, C2, and D1-D4, were evaluated for stain release properties by Test Method 4. The results are presented in Table 9.

TABLE 9

| | | | Stain Release, | | |
|---|---|---|---|---|---|
| | | | TM4** (Mustard Stain) | | |
| | Fluorinated | | After washes (a) | | |
| Example | Additive | Color | Initial | 1 | 3 |
| 3 | 2 | Brown | 4.5 | 3.5 | 4 |
| 4 | 1 | Brown | 5 | 5 | 5 |
| 5 | 1 | Tan | 4 | 4 | 4 |
| 6 | 1 | Tan | 3 | 2 | 1.5 |

Non-fluorinated Additive (Comparative Examples)

| | | | | | |
|---|---|---|---|---|---|
| C1 | Silicone | Tan | 3 | 3.5 | 2.5 |
| C2 | None | Tan | 1 | 1 | 1 |
| D1 | None | Pink | 1 | 1 | 1 |
| D2 | None | Tan | 1 | 1 | 1 |
| D3 | None | Off-White | 1 | 1 | 1 |
| D4 | None | Light Green | 1 | 1 | 1 |

Fluorinated Additives 1 and 2 and Silicone, see Materials above.
**TM4 is Test Method 4.
(a) The samples were tested initially (before any wash), and after 1 and 3 launderings as described above.

Table 9 shows treating the leather of Examples 3-7 with Fluorinated Additive 1 or 2 greatly enhanced stain release of mustard stains, and that the stain property was durable.

What is claimed is:

1. A method of imparting durable oil repellency, durable stain release, and durable water repellency to washable leather comprising contacting said washable leather with a composition which comprises at least one fluorinated urethane, at least one fluorinated ester, or a mixture thereof.

2. The method of claim 1 wherein said composition further comprises at least one fluorinated citrate urethane.

3. The method of claim 1 wherein the fluorinated urethane is a dispersion of a polymer having at least one urea linkage derived by reacting (1) at least one polyisocyanate, or mixture of polyisocyanates, (2) at least one fluorocarbon alcohol, fluorocarbon thiol, or fluorocarbon amine (3) at least one straight or branched chain alcohol, amine or thiol, and (4) at least one alcohol containing a sulfonic acid group or its salt, and then (5) optionally at least one linking agent.

4. The method of claim 1 wherein the fluorinated ester is a dispersion of an oligomer or polymer having the structure of Formula 1 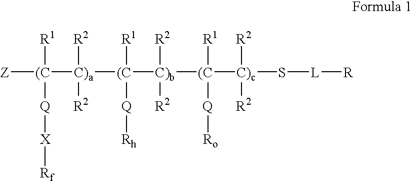
wherein:
Z is a hydrogen atom or a group derived from a free radical initiator;
a is a positive integer and at least 4;
b and c are independently zero or a positive integer;
the sum (a+b+c) is a number such that the molecular weight is less than 1,000,000,
each R¹ is independently hydrogen, halogen, or straight chain or branched chain alkyl containing 1 to about 4 carbon atoms;
each R² is independently hydrogen or straight chain or branched chain alkyl containing 1 to about 4 carbon atoms;
X is a divalent linking radical of formula —(CH₂)ₚ or —SO₂N(R₁)CH₂CH₂—, wherein p is 1 to about 20; and R₁ is an alkyl of 1 to about 4 carbon atoms;
each Q is independently a covalent bond, a straight chain or branched chain or cyclic alkylene, arylene, aralkylene, oxy, thio, sulfonyl, sulfoxy, amino, imino, sulfonamido, carboxamido, carbonyloxy, urethanylene, urylene, or combinations thereof;
S is a sulfur atom;
R is a saturated or unsaturated aliphatic moiety of at least 8 carbon atoms;
R_{f} is a C₄-C₂₀ linear or branched fluorocarbon chain;
Rₕ is a fluorine-free aliphatic group having 18 or fewer carbon atoms;
Rₒ is a polyoxyalkylene group; and
L is a covalent bond, straight chain or branched chain or cyclic alkylene, arylene, aralkylene, oxy, sulfonyl, sulfoxy, amino, imino, sulfonamido, carboxamido, carbonyloxy, urethanylene, ureylene, or combinations thereof.

5. The method of 1 wherein the composition is a mixture of
A) a dispersion of a fluorinated urethane polymer having at least one urea linkage derived by contacting (1) at least one polyisocyanate, or mixture of polyisocyanates, (2) at least one fluorocarbon alcohol, fluorocarbon thiol, or fluorocarbon amine (3) at least one straight or branched chain alcohol, amine or thiol, and (4) at least one alcohol containing a sulfonic acid group or its salt, and then (5) optionally at least one linking agent, and
B) a dispersion of a fluorinated ester which is an oligomer or polymer having the structure of Formula 1 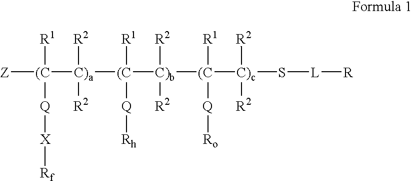
wherein:
Z is a hydrogen atom or a group derived from a free radical initiator;
a is a positive integer and at least 4;
b and c are independently zero or a positive integer;
the sum (a+b+c) is a number such that the molecular weight is less than 1,000,000,
each R¹ is independently hydrogen, halogen, or straight chain or branched chain alkyl containing 1 to about 4 carbon atoms;
each R² is independently hydrogen or straight chain or branched chain alkyl containing 1 to about 4 carbon atoms;
X is a divalent linking radical of formula —(CH₂)ₚ or —SO₂N(R₁)CH₂CH₂—, wherein p is 1 to about 20; and R₁ is an alkyl of 1 to about 4 carbon atoms;
each Q is independently a covalent bond, a straight chain or branched chain or cyclic alkylene, arylene, aralkylene, oxy, thio, sulfonyl, sulfoxy, amino, imino, sulfonamido, carboxamido, carbonyloxy, urethanylene, urylene, or combinations thereof;
S is a sulfur atom;
R is a saturated or unsaturated aliphatic moiety of at least 8 carbon atoms;
R_{f} is a C₄-C₂₀ linear or branched fluorocarbon chain;
Rₕ is a fluorine-free aliphatic group having 18 or fewer carbon atoms;
Rₒ is a polyoxyalkylene group; and
L is a covalent bond, straight chain or branched chain or cyclic alkylene, arylene, aralkylene, oxy, sulfonyl, sulfoxy, amino, imino, sulfonamido, carboxamido, carbonyloxy, urethanylene, ureylene, or combinations thereof.

6. The method of claim 2 wherein the composition is a mixture of
A) a dispersion of a fluorinated urethane polymer having at least one urea linkage derived by contacting (1) at least one polyisocyanate, or mixture of polyisocyanates, (2) at least one fluorocarbon alcohol, fluorocarbon thiol, or fluorocarbon amine (3) at least one straight or branched chain alcohol, amine or thiol, and (4) at least one alcohol containing a sulfonic acid group or its salt, and then (5) optionally at least one linking agent, and
B) a dispersion of a fluorinated citrate urethane.

7. The method of claim 6 wherein the weight ratio of fluorinated urethane dispersion to fluorinated citrate urethane dispersion is from about 1:0 to about 1:1.5.

8. The method of claim 1 wherein the amount of fluorinated dispersion contacted with the washable leather is from about 1% to about 12% by weight based on the weight of wet blue hide employed.

9. The method of claim 1 wherein the amount of fluorine contacted with the washable leather is an amount to provide at least about 0.2 g fluorine/m² in the dried washable leather.

10. The method of claim 9 wherein the amount provides at least 0.5 g fluorine/m² in dried washable leather.

11. The method of claim 1 wherein the contacting occurs during the tanning of the washable leather.

12. The method of claim 11 wherein the contacting is at the point in the tanning process just prior to a final rinsing and drying step.

13. The method of claim 11 wherein the contacting is in an aqueous bath having a pH of from about 2.5 to about 4.0, at a temperature of from about 30° C. to about 70° C.

14. Washable leather prepared according to the method of claim 1.

15. A washable leather treated to provide durable oil repellency, durable stain release, and durable water repellency by contacting said leather with a composition which comprises at least one fluorinated urethane, at least one fluorinated ester, or a mixture thereof.

16. The leather of claim 15 wherein the composition further comprises at least one fluorinated citrate urethane.

17. The washable leather of claim 15 wherein the fluorinated urethane is a polymer having at least one urea linkage derived by reacting (1) at least one polyisocyanate, or mixture of polyisocyanates, (2) at least one fluorocarbon alcohol, fluorocarbon thiol or fluorocarbon amine, (3) at least one straight or branched chain alcohol, amine or thiol, and (4) at least one alcohol containing a sulfonic acid group or its salt, and then (5) optionally at least one linking agent.

18. The washable leather of claim 15 wherein the fluorinated ester is a dispersion of an oligomer or polymer having the structure of Formula 1 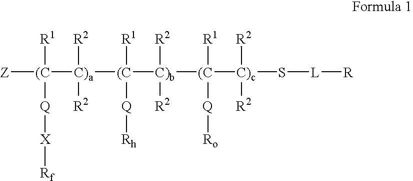
wherein:
Z is a hydrogen atom or a group derived from a free radical initiator;
a is a positive integer and at least 4;
b and c are independently zero or a positive integer;
the sum (a+b+c) is a number such that the molecular weight is less than 1,000,000,
each R¹ is independently hydrogen, halogen, or straight chain or branched chain alkyl containing 1 to about 4 carbon atoms;
each R² is independently hydrogen or straight chain or branched chain alkyl containing 1 to about 4 carbon atoms;
X is a divalent linking radical of formula —(CH₂)ₚ or —SO₂N(R₁)CH₂CH₂—, wherein p is 1 to about 20; and R₁ is an alkyl of 1 to about 4 carbon atoms;
each Q is independently a covalent bond, a straight chain or branched chain or cyclic alkylene, arylene, aralkylene, oxy, thio, sulfonyl, sulfoxy, amino, imino, sulfonamido, carboxamido, carbonyloxy, urethanylene, urylene, or combinations thereof;
S is a sulfur atom;
R is a saturated or unsaturated aliphatic moiety of at least 8 carbon atoms;
R_{f} is a C₄-C₂₀ linear or branched fluorocarbon chain;
Rₕ is a fluorine-free aliphatic group having 18 or fewer carbon atoms;
Rₒ is a polyoxyalkylene group; and
L is a covalent bond, straight chain or branched chain or cyclic alkylene, arylene, aralkylene, oxy, sulfonyl, sulfoxy, amino, imino, sulfonamido, carboxamido, carbonyloxy, urethanylene, ureylene, or combinations thereof.

19. The washable leather of claim 15 wherein the mixture is of
A) a dispersion of a polymer having at least one urea linkage derived by contacting (1) at least one polyisocyanate, or mixture of polyisocyanates, (2) at least one fluorocarbon alcohol, fluorocarbon thiol, or fluorocarbon amine (3) at
least one straight or branched chain alcohol, amine or thiol, and (4) at least one alcohol containing a sulfonic acid group or its salt, and then (5) optionally at least one linking agent, and
B) a dispersion of a fluorinated citrate urethane.

20. The washable leather of claim 15 which has a fluorine content of at least about 0.2 g fluorine/m² in the dried washable leather.
